(19) United States
(12) Patent Application Publication
(10) Pub. No.: US 2014/0358690 A1
(43) Pub. Date: Dec. 4, 2014

(54) METHOD AND SYSTEM FOR USER IDENTIFICATION AND COMMUNICATION

(71) Applicant: SHOUTZ, INC., Austin, TX (US)

(72) Inventors: James G. Mueller, Austin, TX (US); Stephen Earl Wright, Lenexa, KS (US)

(73) Assignee: SHOUTZ, INC., Austin, TX (US)

(21) Appl. No.: 14/288,808

(22) Filed: May 28, 2014

Related U.S. Application Data
(60) Provisional application No. 61/855,909, filed on May 28, 2013.
(60) Provisional application No. 61/855,916, filed on May 28, 2013.

(51) Int. Cl. G06Q 30/02

(52) U.S. Cl. CPC G06Q 30/0267
USPC 705/14.64

(57) ABSTRACT

Method and system is disclosed for identifying and communicating with a user across a multi-connected networked environment such as through both telephony and internet-based networks. The method includes receiving a predefined keyword directed to a predefined shortcode from a mobile device, storing a phone number associated with the mobile device, generating a unique URL address based upon the keyword, the shortcode and the stored phone number, transmitting the unique URL address to the mobile device, receiving a request from the mobile device to access the unique URL address, resolving the unique URL address to a second URL address comprising numerical digits of the phone number, recording user interactions with the website based upon the second URL address, and communicating information to the user via the mobile device based upon the stored phone number and the second URL address.

### CROSS-REFERENCE TO RELATED APPLICATIONS

This application claims the benefit of U.S. Provisional Application No. 61/855,909 filed May 28, 2013 and U.S. Provisional Application No. 61/855,916 filed May 28, 2013 which are hereby incorporated herein by reference in their entirety, except that the present application supersedes any portion of the above referenced application which is inconsistent with the present application.

### TECHNICAL FIELD

This disclosure relates to systems and methods for identifying and communicating with a user, and more specifically to systems and methods for identifying a user and communicating with a user via a URL address.

### BACKGROUND

The statements in this section merely provide background information related to the present disclosure and may not constitute prior art.

The Internet has transformed both consumer sales and advertising. Where once a person had to physically visit a store to review the available merchandise and make a selection, now people can sit in front of a computer in their home and review a vast array of selections and offerings. Once a consumer has decided to purchase an item, they can initiate an online purchase and have the item shipped directly to their home. Before online sales and product promotion, companies had to strategically market and promote their offerings to consumers, through traditional media such as television, newspapers or billboards and hope that the consumers were paying attention as they drove by the billboard or read the article on that page of the newspaper.

With the Internet, numerous, dynamic advertisements can be marketed to consumers on a website-to-website basis, via mobile software application, or based upon selected downloaded content. Further, the ability to gather information on users and the flexibility of digital media allow advertisers to be precise in targeting their ads, has generated complex marketing and promotional strategies.

Mobile communications devices such as smart phones and tablets devices are further transforming consumer sales and advertising. Instead of having to be in front of a desktop computer, consumers can shop and purchase from almost anywhere they have cell phone coverage. An advertisement can be delivered to an individual's smart phone or tablet, with the device notifying the individual of the availability of the ad. Further, the global positioning systems (GPS) and cameras built into mobile devices provide new ways to target ads to consumers and to provide inducements or rewards. Using GPS, a person can be presented with ads based upon their current location and proximity to offered products and services.

The ubiquity and intrusiveness of mobile devices also pose challenges for consumer sales and advertising. People are increasingly inundated with information and advertising, making it more difficult for a company or advertiser to engage an attentive consumer. Games have historically captured people's attention. The opportunity to win something based on luck, not skill or mental exertion, can give people a sense of anticipation, increasing attentiveness and engagement with potential advertisement messages.

Mobile devices allow games to be delivered directly to a consumer, providing a quick and easy respite from the real world. Further, mobile devices can be used to instantly deliver the prize or award, continuing the consumer's engagement. For companies selling to and advertising to consumers, games offer a unique engagement tool, something that can be used to capture and keep a consumer's attention and allow the presentation of a special offer or advertisement.

The ubiquity of mobile devices and revenue generating ability of mobile devices has made identifying and gathering phone numbers of consumers increasingly important for a retailer. If a retailer has the phone number of a customer with pre-approval, the retailer can send the customer information on available products and special offers and further can target the offers based on previous buying patterns, location, age or a range of factors. Loyalty and rewards programs can be built into a marketing and advertisement strategy based upon identifying consumers through their phone numbers. Active loyalty participants make a point to shop at the retailer, increasing visits and revenue. Loyalty programs allow retailers to reward their best customers with special offers and other benefits, creating greater brand loyalty and stickiness.

Retailers pursue a range of strategies to collect phone numbers from consumers. One known method includes supplying the phone number as part of a registration process. Registration is an overt process requiring effort and engagement by a consumer. Typically, a consumer will successfully complete registration in order to gain some benefit, e.g., coupon, information, shipping and tracking premiums.

Short codes, or short numbers, are widely used for a broad range of engagement and communications activities with mobile devices and their users. Short codes work in conjunction with SMS and MMS messaging, allowing a mobile phone user to send a short text message or keyword to the short code. The received short code can generate a range of actions, for example, removing someone from a texting, list, registering a vote in support of an artist, authorizing a donation, generating a return text with a URL or web link, or entering the mobile phone user in a contest or giveaway.

Short codes with links to URL/web addresses have become critical components of many smart phone text message marketing and engagement campaigns. In some known embodiments, enabling a URL/web address causes the phone's browser to open and the mobile friendly web page to be displayed. The displayed web pages often prompt users to enter their phone numbers, either as part of a registration process or facilitate tracking of repeat visitors and targeting of offers and content. Users are sometimes hesitant to enter their phone numbers, however, causing some users to drop off.

Further, multi-connected environments such as a telephony-based communication network and internet-based environments, often present difficulties to retailers to identify and communicate with individual users as they switch between telephony communication and internet communication. Hence, there is a need for identifying and communicating with users via a unique URL address associated with a user's phone number. Retailers particularly would benefit from such a system and method for identifying phone numbers and associating the phone number with a unique URL.

### SUMMARY

A method and system is disclosed for identifying and communicating with users via a unique URL address associated with a user's phone number. The method includes receiving a predefined keyword directed to a predefined shortcode from a mobile device, storing a phone number associated with the mobile device, generating a unique URL address based upon the keyword, the shortcode and the stored phone number, transmitting the unique URL address to the mobile device, receiving a request from the mobile device to access the unique URL address, resolving the unique URL address to a second URL address comprising numerical digits of the phone number, recording user interactions with the website based upon the second URL address, and communicating information to the user via the mobile device based upon the stored phone number and the second URL address.

Certain embodiments of the invention are particularly useful in multi-networked environments such as telephony and internet-based networks.

This summary is provided merely to introduce certain concepts and not to identify key or essential features of the claimed subject matter.

### BRIEF DESCRIPTION OF THE DRAWINGS

One or more embodiments will now be described, by way of example, with reference to the accompanying drawings, in which:

FIG. 1 schematically shows an exemplary realtor system, in accordance with an embodiment of the present disclosure;

FIG. 2 schematically shows an exemplary server, in accordance with an embodiment of the present disclosure;

FIG. 3 schematically shows an exemplary mobile device, in accordance with an embodiment of the present disclosure;

FIG. 4 schematically shows a process for identifying and communicating with a user, in accordance with an embodiment of the present disclosure;

FIG. 5 shows exemplary embodiments of a URL address as used by the system, in accordance with an embodiment of the present disclosure; and

FIG. 6 shows an exemplary user interface for the mobile device depicting an exemplary game, in accordance with an embodiment of the present disclosure.

### DETAILED DESCRIPTION

Throughout the specification and claims, the following terms take at least the meanings explicitly associated herein, unless the context dictates otherwise. The meanings identified below do not necessarily limit the terms, but merely provide illustrative examples for the terms. The meaning of “a,” “an,” and “the” includes plural reference, and the meaning of “in” includes “in” and “on.” The phrase “in one embodiment,” as used herein does not necessarily refer to the same embodiment, although it may. Similarly, the phrase “in some embodiments,” as used herein, when used multiple times, does not necessarily refer to the same embodiments, although it may. As used herein, the term “or” is an inclusive “or” operator, and is equivalent to the term “and/or,” unless the context clearly dictates otherwise. The term “based, in part, on”, “based, at least in part, on”, or “based upon” is not exclusive and allows for being based on additional factors not described, unless the context clearly dictates otherwise. Any embodiment described herein as “exemplary” is not necessarily to be construed as preferred or advantageous over other embodiments.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

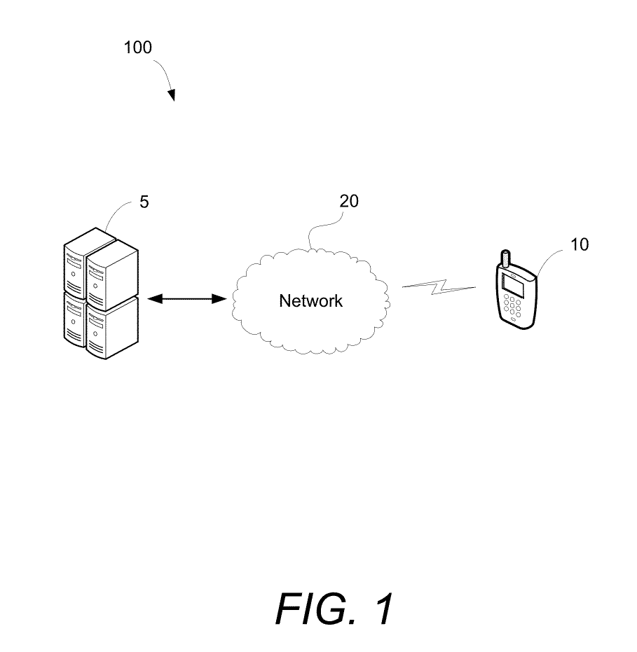

Referring now to the drawings, wherein the depictions are for the purpose of illustrating certain exemplary embodiments only and not for the purpose of limiting the same, FIG. 1 schematically shows an exemplary retail system 100 that may help implement the methodologies of the present disclosure. The system 100 includes a server system 5, a network 20, and a mobile device 10. As shown in FIG. 1, the server system 5 may be directly communicatively connected to the mobile device 10 via the network 20. The mobile device 10 may be physically connected to the network 20 during selected periods of operation without departing from the teachings herein. Components of the system 100 are shown in FIG. 1 as single elements. Such illustration is for ease of description and it should be recognized that the system 100 may include multiple additional mobile devices.

The network 20 may be any suitable series of points or nodes interconnected by communication paths. The network 20 may be interconnected with other networks and contain sub networks network such as, for example, a publicly accessible distributed network like the Internet or other telecommunications networks (e.g., intranets, virtual nets, overlay networks and the like). The network 20 may facilitates the exchange of data between and among the mobile device 10 and the server system 5 although in various embodiments the mobile device 10 may be directly connected to the server 5.

The server system 5 may be: various embodiments of a computer including high-speed microcomputers, minicomputers, mainframes, and/or data storage devices. The server system 5 preferably executes database functions including storing and maintaining a database and processes requests from the mobile device 10 to extract data from, or update, a database as described herein below. The server 5 may additionally provide processing functions for the mobile device 10 as will become apparent to those skilled in the art upon a careful reading of the teachings herein.

In addition, the mobile device 10 may include one or more applications that the user may operate. Operation may include downloading, installing, turning on, unlocking, activating, or otherwise using the application. The application may comprise at least one of an algorithm, software, computer code, and/or the like, for example, mobile application software. In the alternative, the application may be a website accessible through the world wide web.

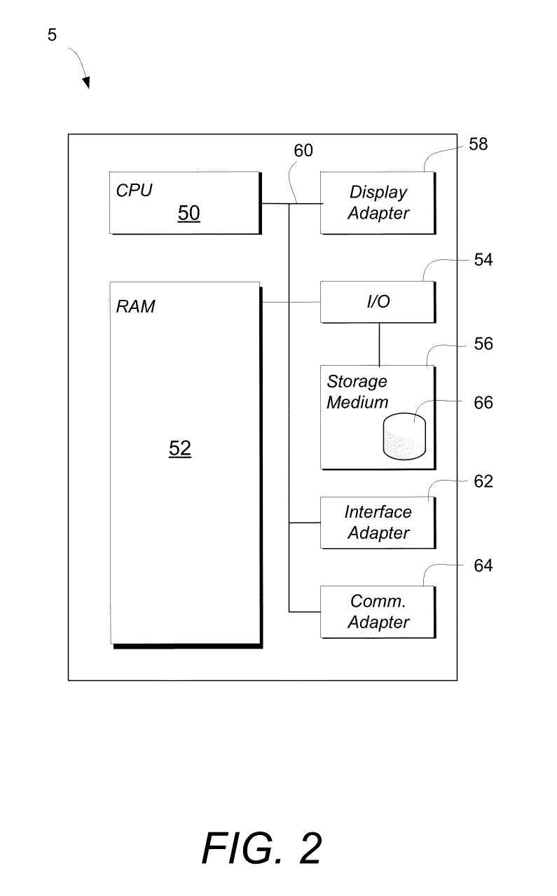

FIG. 2 shows the exemplary server 5. The server 5 includes a central processing unit (CPU) 50, random access memory (RAM) 52, input/output circuitry 54 for connecting peripheral devices such as a storage medium 56 to a system bus 60, a display adapter 58 for connecting the system bus 60 to a display device, a user interface adapter 62 for connecting user input devices such as a keyboard, a mouse, and/or a microphone, to the system bus 60, and a communication adapter 64 for connecting the server 5 to the network 20. In one embodiment, the communication adapter 64 is a wireless adapter configured for extraterrestrial communication such as in a communications satellite. The storage medium 56 is configured to store, access, and modify a database 66, and is preferably configured to store, access, and modify structured or unstructured databases for data including, for example, relational data, tabular data, audio/video data, and graphical data.

The central processing unit 50 is preferably one or more general-purpose microprocessor or central processing unit(s) and has a set of control algorithms, comprising resident program instructions and calibrations stored in the memory 52 and executed to provide the desired functions including parallel processing functions. As one skilled in the art will recognize, the central processing unit 50 may have any number of processing “cores” or electronic architecture configured to execute processes in parallel. In one embodiment, an application program interface (API) is preferably executed by the operating system for computer applications to make requests of the operating system or other computer applications. The description of the central processing unit 50 is meant to be illustrative, and not restrictive to the disclosure, and those skilled in the art will appreciate that the disclosure may also be implemented on platforms and operating systems other than those mentioned.

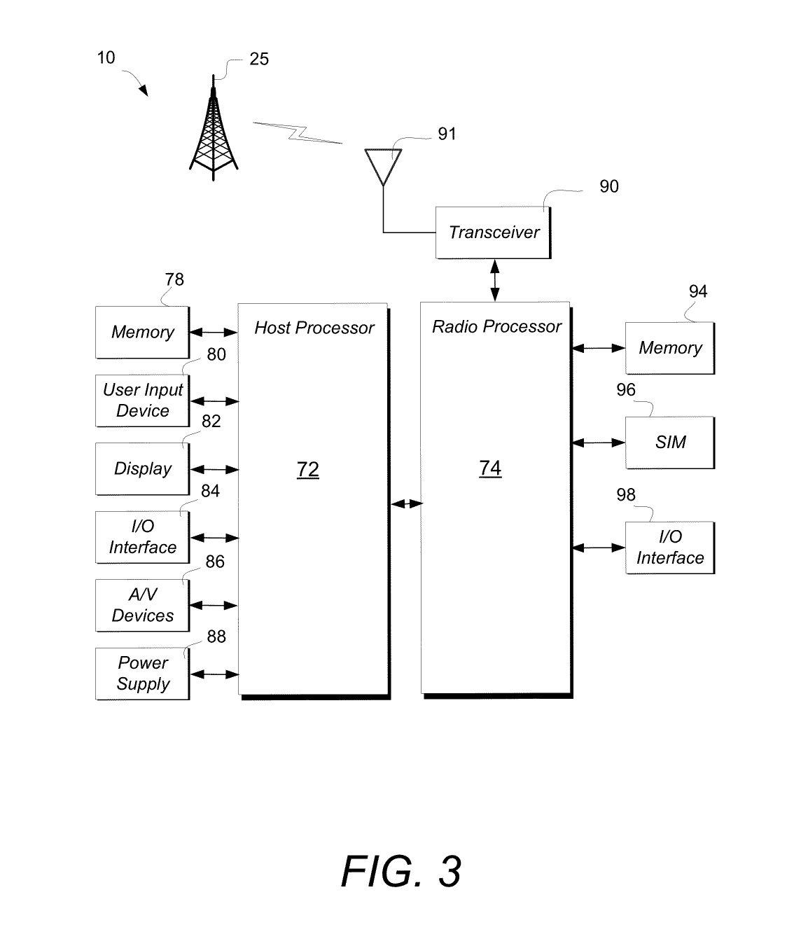

FIG. 3 schematically shows an exemplary embodiment of the device 10 configured to operate in a mobile environment. As shown in FIG. 3, the device 10 may include a dual processor architecture, including a host processor module 72 and a radio processor 74 (e.g., a base band processor or modem). The host processor module 72 and the radio processor 74 may be configured to communicate with each other using an interface 76. The device 10 may additionally include any digital and/or analog circuit elements, comprising discrete and/or solid state components, suitable for use with the embodiments disclosed herein. One skilled in the art will recognize upon a careful reading of the teachings herein that the radio processor may be omitted in a wired embodiment of the device 10.

The host processor module 72 may be configured to execute various computer programs (e.g., software, firmware, or other code) such as application programs and system programs to provide computing and processing operations for the device 10. The radio processor 74 may be responsible for performing data communications operations for device 10 such as transmitting and receiving data information over one or more wireless communications channels. Although the host processor module 72 and the radio processor 74 are shown and described as separate processors, such an illustration is for ease of description and it should be recognized that the functions performed by the host processor module 72 and the radio processor 74 may be combined on a single chip.

In various embodiments, host processor module 72 may be implemented as a host central processing unit (“CPU”) using any suitable processor or logic device, such as a general purpose processor, or other processing device in alternative embodiments configured to provide processing or computing resources to device 10. For example, host processor module 72 may be responsible for executing various computer programs such as application programs and system programs to provide computing and processing operations for device 10. The application software may provide a graphical user interface (“GUI”) to communicate information between device 10 and a user. The computer programs may be stored as firmware on a memory associated with processor 72, may be loaded by a manufacturer during a process of manufacturing device 10, and may be updated from time to time with new versions or software updates via wired or wireless communication.

System programs assist in the running of a computer system. System programs may be directly responsible for controlling, integrating, and managing the individual hardware components of the computer system. Examples of system programs may include, for example, an operating system, a kernel, device drivers, programming tools, utility programs, software libraries, an application programming interface (“API”), a GUI, and so forth.

The memory module 78 is preferably coupled to the host processor module 72. In various embodiments, the memory module 78 may be configured to store one or more computer programs to be executed by the host processor module 72. The memory module 78 may be implemented using any machine-readable or computer-readable media capable of storing data such as volatile memory or non-volatile memory, removable or non-removable memory, erasable or non-erasable memory, writeable or re-writeable memory, and so forth. Although the memory module 78 is shown as being separate from the host processor module 72 for purposes of illustration, in various embodiments some portion or the entire memory module 78 may be included on the same integrated circuit as the host processor module 72. Alternatively, some portion or the entire memory module 78 may be disposed on an integrated circuit or other medium (e.g., solid state drive) external to the integrated circuit of the host processor module 72.

A user input device 80 may be coupled to the host processor module 72. The user input device 80 may include, for example, an alphanumeric, numeric key layout and an integrated number dial pad. The device 10 also may include various keys, buttons, and switches such as, for example, input keys, preset and programmable hot keys, left and right action buttons, a navigation button such as a multidirectional navigation button, power/end buttons, preset and programmable shortcut buttons, a volume rocker switch, a ringer on/off switch having a vibrate mode, a keypad and so forth.

The host processor module 72 may be coupled to a display device 82. The display device 82 may include any suitable visual interface for displaying content to a user of the device 10, such as a liquid crystal display (“LCD”) such as a touch-sensitive color (e.g., 16-bit color) thin-film transistor (“TFT”) LCD screen. In some embodiments, the touch-sensitive LCD may be used with a stylus and/or a handwriting recognizer program.

An I/O interface 84 is preferably coupled to the host processor module 72. The I/O interface 84 may include one or more I/O devices such as a serial connection port, an infrared port, wireless capability, and/or integrated 802.11x (WiFi) wireless capability, to enable wired (e.g., USB cable) and/or wireless connection to a local or networked computer system, such as a workstation client, and/or the server 5.

In one embodiment, the device 10 includes an audio/video (“A/V”) module 86 coupled to the host processor module 72 for communicatively connecting and communicating therebetween to various audio/video devices. The A/V module 86 may be configured to support A/V capability of the device 10 including components such as, a microphone, one or more speakers, an audio port to connect an audio headset, an audio coder/decoder (codec), an audio player, a video codec, a video player, and so forth. The A/V input module 86 may include an imaging module configured to capture digital images. The imagining module may include an optical sensor, e.g., a charged coupled device (CCD) or a complementary metal-oxide semiconductor (CMOS) optical sensor to facilitate camera functions, such as recording photographs and video clips. The image frames may be processed by the memory 78 or displayed on the display 82.

A power supply 88 configured to supply and manage power to components of device 10 is preferably coupled to the host processor module 72. In various exemplary embodiments, the power supply 88 may be implemented by a rechargeable battery, such as a removable and rechargeable lithium ion battery to provide direct current (“DC”) power, and/or an alternating current (“AC”) adapter to draw power from a standard AC main power supply.

As described herein above, the radio processor 74 may perform voice and/or data communication operations for the device 10. For example, the radio processor 74 may be configured to communicate voice information and/or data information over one or more assigned frequency bands of a wireless communication channel. The radio processor 74 may be implemented as a communications processor using any suitable processor or logic device, such as a modem processor or baseband processor. The radio processor 74 may include, or be implemented as, a digital signal processor (“DSP”), a media access control (“MAC”) processor, or any other type of communications processor in accordance with the described embodiments. Memory 94 may be coupled to the radio processor 74. Although memory 94 is shown as being separate from and external to the radio processor 74 for purposes of illustration, in various embodiments some portion may be included on the same integrated circuit as the radio processor 74. Further, the host processor module 72 and the radio processor 74 may share a single memory.

The device 10 may include one or more transceivers 90 coupled to the radio processor 74, each transceiver 90 may be configured to communicate using a different types of protocol, communication ranges, operating power requirements, RF sub-bands, information types (e.g., voice or data), use scenarios, applications, and so forth. For example, the transceiver 90 may include a Wi-Fi transceiver and a cellular or WAN transceiver configured to operate simultaneously. The transceiver 90 may be implemented using one or more chips as desired for a given implementation. Although transceiver 90 is shown as being separate from and external to the radio processor 74 for purposes of illustration, in various embodiments some portion may be included on the same integrated circuit as the radio processor 74. The transceiver is preferably connected to an antenna 91 for transmitting and/or receiving electrical signals. As shown in FIG. 3, the antenna 91 may be coupled to the radio processor 74 through transceiver 90.

A SIM device 96 may be coupled to radio processor 74. The SIM device 96 may be implemented as a removable or non-removable smart card configured to encrypt voice and data transmissions and to store user-specific data for allowing a voice or data communications network to identify and authenticate the user. The SIM device 96 also may store data such as personal settings specific to the user.

An I/O interface 98 may be coupled to the radio processor 74. The I/O interface 98 may include one or more I/O devices to enable wired (e.g., serial, cable, etc.) and/or wireless (e.g., WiFi, short range, etc.) communication between the device 10 and one or more external computer systems.

In addition to receiving email messages, Instant Messaging (IM) messages, and Short Message Service (SMS) text messages, many embodiments of the mobile device 10 may utilize short codes. Short codes are typically short strings of numbers or characters to which a text message may be addressed, e.g., a 5-digit number. Short codes are routed by a predetermined network carrier addressing protocol that generally includes a common addressing scheme for participating wireless networks. Short codes are designed to provide a way to deploy interactive mobile data applications, including voting, polling, “text and win” contests, surveys, focus groups, direct marketing, live chats, games, and the like.

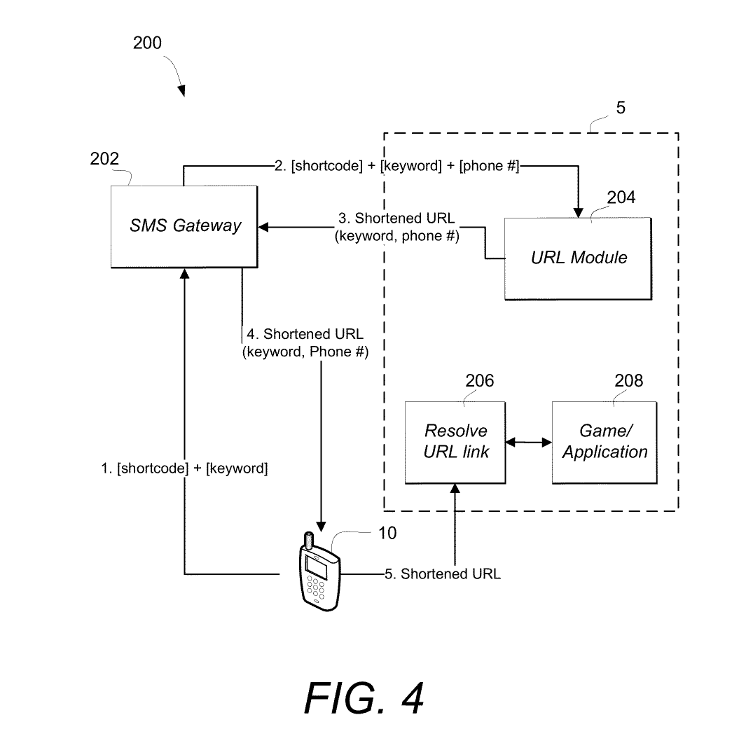

FIG. 4 schematically shows a system 200 configured to execute a process for identifying and communicating with a user via a unique URL address associated with the user's phone number. The process begins when a user sends information such as a text keyword via a shortcode from the mobile device 10 to an SMS Gateway 202. The information may be sent over the network 20 as described herein above. For example, a user sends the text keyword: “Play” to the exemplary shortcode: 72727. The SMS Gateway 202 then receives the keyword from the mobile device 10 and captures the phone number associated with the mobile device 10 used to send the text message using the shortcode, e.g., 775-234-5678. The SMS Gateway 202 sends the keyword, shortcode and phone number to the URL module 204. The URL module 204 can be operated by the SMS Gateway provider or can be a separate third party or internal provider.

The URL module 204 transmits a unique shortened URL address 220 to the SMS Gateway 202 containing the appropriate web address and a key value pairing. The key value pairing can contain the phone number alone or the phone number and additional information. For example, in one embodiment the key value pairing includes the phone number and the keyword. In one embodiment, the key value pairing includes the phone number and the short code. In one embodiment, the key value pairing includes the phone number, the keyword and the short code. In one embodiment, information in the key value pairing is encrypted. In one embodiment, the key value paring is encrypted alpha-numeric characters of the phone number.

Subsequent to the transmitting from the URL module 204 to the SMS Gateway 202, the SMS Gateway 202 then sends the unique shortened URL address 220 address to the mobile device 10. In one embodiment, when the user clicks or otherwise actuates the unique shortened URL address, the mobile device 10 opens a web browser and navigates to the web address associated with the unique shortened URL address.

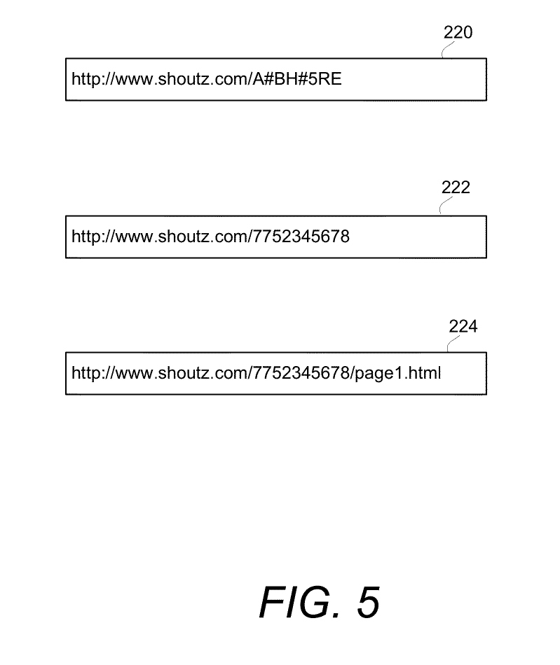

The unique shortened URL address 220 resolves to the site of the shortened URL 220. In one embodiment, resolving the address redirects the web browser to the full length URL containing the captured phone number such as shown in exemplary address 222 in FIG. 5. The address 222 may include the numerical digits of the phone number in an ordered sequence, in one embodiment. The server 5 opens the appropriate website and captures the key value pair at the end of the URL, recording the phone number and any other additional information. In one embodiment, the phone number is used as a targeting key to provide targeted content or offerings particular to an identified user. In one embodiment, the phone number is used as a form of cookie to track repeat visits and on-site activity. In one embodiment, the phone number is used to populate a web form.

In one embodiment, the URL containing the captured phone number may be used as a root webpage such as shown in FIG. 5 as address 224. Website analytical data may be gathered, generated, and indexed by particular phone numbers and their corresponding users. In one embodiment the system records user interactions with the website based upon the URL address containing the captured phone number. For example, tracking navigation, use, and informational exchanges by the URL address containing the captured phone number.

In one embodiment, the system 100 is configured to provide access to a game based upon a transmitted keyword to a designated number or short code 208. As above, the user sends information such as a text keyword via a shortcode from the mobile device 10 to an SMS Gateway. For example, a user sends the text keyword: “Game” to the exemplary shortcode: 72727. The SMS Gateway receives the keyword from the mobile device 10 and captures the phone number associated with the mobile device 10 used to send the text message using the shortcode, e.g., 775-234-5678. The SMS Gateway sends the keyword, shortcode and phone number to the URL module.

The URL module 204 transmits a unique URL to the SMS Gateway 202 containing the associated web address and the key value pairing associated with the keyword. The SMS Gateway 202 then sends the unique shortened URL address to the mobile device 10. When the user clicks or otherwise actuates the unique shortened URL address, the mobile device 10 opens a web browser and navigates to the web address associated with the unique shortened URL address. The unique shortened URL address resolves to the site of the shortened URL, which then redirects the web browser to the full length URL containing the captured phone number and the game. The server 5 opens the appropriate website page associated with the game and captures the key value pair at the end of the URL, recording the phone number and any other additional information.

In one embodiment, the phone number is transmitted to a game delivery module. The game delivery module checks the phone number against its database and selects the game to be presented to the user. Once a user has transmitted their phone number, the game delivery module presents the games, advertisements and offers as specified by the retailer.

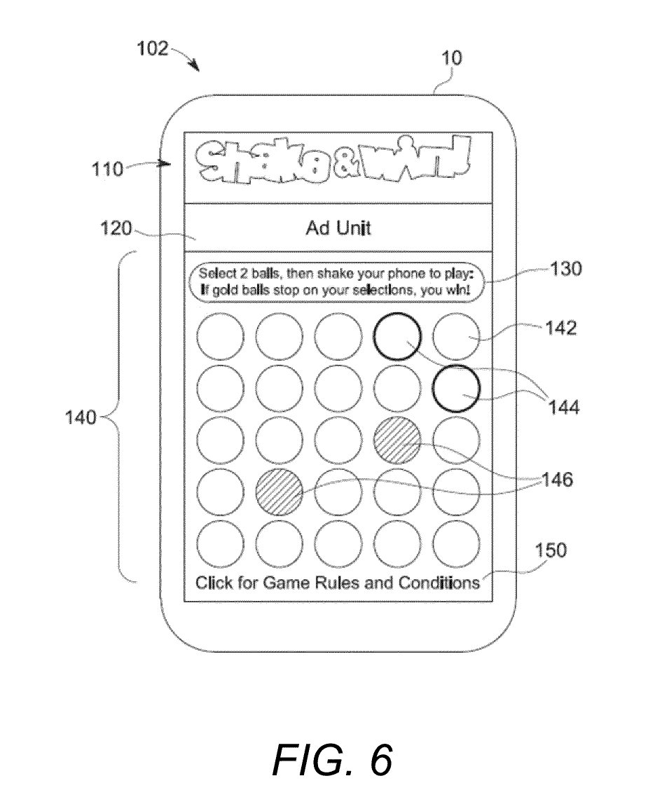

FIG. 6 shows an exemplary user interface 102 for the mobile device 10 depicting an exemplary game. The exemplary user interface 102 is configured to enable a user to interface with a gaming application. The gaming application may include a mobile module and a game operation module. The game operation module may be hosted on the server system 5 and communicatively accessible via the network 20, on a private network, or may reside on the mobile device 10. The mobile module may be an application that is downloaded to and resides on the mobile device or can be a located at an Internet address and accessed by the mobile device 10 via the network 20, i.e., the Internet.

As FIG. 6 shows, the user interface 102 preferably includes a menu or title module 110, an advertisement module 120, a navigational module or button 130, an interactive playing module 140, and a navigational link 150. The title module 110 may include a game logo. The title module may include one or more navigational links such as a hyperlink. In one embodiment, the title module 110 may be configured to display gaming application information such as update notifications. The advertisement module 120 may include a banner advertisement and/or a video advertisement. The navigational module 130 may include an informational display component. The information communicated to the user may include game rules or instructions. The interactive playing module 140 is configured to display gameplay and accept user input. Functions of the device may display as hyperlinks to pages and/or informational modules e.g., the navigational link 150 may be hyperlinked to a webpage having a terms and conditions license.

Initially a mobile device user, i.e., user-player, is presented with an opportunity to play the game. This opportunity can be delivered in accordance of a previously expressed desire to receive games and so pushed to the mobile device 10. The game opportunity could also be an outcome of a previous interaction, for example a person that has played and lost the lottery can be automatically presented with a second game. Further, the game opportunity could be automatically presented to the user based on their physical location as derived from the phone's GPS or in response to the mobile device user scanning a QR code on a poster.

Gameplay of the gaming application includes providing, in response to a request from a user, a game comprising a plurality of identifiable game pieces 142, the game pieces displayed on the interactive playing module 140, i.e., a playing surface. The mobile device 10 receives, from the server 5, an advertisement for display adjacent to the playing surface. The game is initiated upon player request, the request may be indicated by player supplied tactile input such as shaking of the mobile device, the shaking determined by monitoring a gyroscope or accelerometer within the mobile device. Game rules are predetermined by a merchant-user or administrator of the game. For example, the game rules may indicate a number of matches of user-selected game pieces 144 to game pieces selected by the gaming application and instruct the game play to select the number of game pieces.

After initiation of a game, a player selects the predetermined number of game pieces. After selection of the game pieces 144, the user is then instructed to shake the mobile device 10. Upon shaking, or a predetermined time period thereafter, the gaming application initiates selection of the game pieces at random. Selection of the game pieces includes a show display to the user. The show display indicates to the user that the gaming application is sorting through the game pieces on the screen in a random process, instead of the nearly instantaneous selection enabled by computing processors available on the mobile device. In one embodiment, the show display includes changing images of the game pieces randomly or sequentially with one or more random stops. Changing images can include a visual highlight or temporary transparent visual modulation. When the random number generator completes its process the randomly selected game pieces are highlighted, along with the corresponding winning game pieces 146 as visual indicia, for example.

FIG. 6 shows the user-selected game pieces 144 and the game pieces selected by the gaming application 146. Insofar as the selection is not congruent, the user-player is considered by the gaming application to have lost the game. When the user-selected game pieces 144 match the game pieces selected by the gaming application, the user-player is considered to have won the game. The game operation module then communicates to the user-player an informational display showing the awarded prize or describing the awarded prize therein. In one embodiment, the game operation module may send notification and the prize via a text message or email to the mobile device of the user-player.

In one embodiment, the system can present an advertisement or special offer to the user before, during or after the conclusions of the game. The system may also prompt the user to select the prize for which they are playing, prior to starting the game. Consumers may enter a preferred prize or select from a list. The system can offer the user the opportunity to opt in to receive email or text message special offers, or can include opting in a condition in the terms the consumer agrees to at the start of the game. Further, the system could combine an advertisement with an opportunity to play the game again, or to play a different game. The system may make joining the retailer loyalty program a pre-condition to receiving the game, or present an offer to join the loyalty program at the conclusion of the game. Further, the system may present games on an ongoing basis to loyalty program members. Different games may be offered each time a user visits the retail location. The system may allow users to play a game a single time, allow the game to be played a predetermined or unlimited amount, or provide multiple games to be played during a single interaction with the user.

In one embodiment, the system includes a phone number receiving module, an outbound text module, game delivery module with game selection controls and a game library containing one or more games. The system may be hosted on a server 5 delivered over the Internet or on a private network.

In use, a retailer uses the game delivery module with game selection controls to select both the games to be offered in different situations and the promotions, links and prize preference options that precede or follow the games. The retailer can select a single game to be offered, or multiple games, with the game selection based on criteria such as previous games played, membership in an incentives or loyalty program or the geographic location of the consumer. The retailer can also designate the information to be presented to a consumer if the consumer wins or loses the game, for example a prize or a right to enter a drawing or sweepstake. The prize can be something delivered to the smart phone for immediate use, for example a number or barcode that can be used for a free drink, the right or option of receiving something at a future date, for example a coupon that can be redeemed online to purchase more lottery tickets. The prize may also be an opportunity to participate in an event, for example sideline passes to the football game the winner is currently attending. Losing players can be offered the opportunity to play again or to be entered into a drawing or sweepstakes.

The disclosure has described certain preferred embodiments and modifications thereto. Further modifications and alterations may occur to others upon reading and understanding the specification. Therefore, it is intended that the disclosure not be limited to the particular embodiment(s) disclosed as the best mode contemplated for carrying out this disclosure, but that the disclosure will include all embodiments falling within the scope of the appended claims.

1. A method for identifying and communicating with a user, the method comprising:
receiving a predefined keyword directed to a predefined shortcode from a mobile device;
storing a phone number associated with the mobile device;
generating a unique URL address based upon the keyword, the shortcode and the stored phone number;
transmitting the unique URL address to the mobile device;
receiving a request from the mobile device to access the unique URL address;
resolving the unique URL address to a second URL address comprising numerical digits of the phone number;
recording user interactions with the website based upon the second URL address; and
communicating information to the user via the mobile device based upon the stored phone number and the second URL address.

2. The method of claim 1, further comprising:
generating user analytic information based upon the second URL address.

3. The method of claim 1, wherein the unique URL address comprises encrypted alpha-numeric characters of the phone number.

4. The method of claim 1, wherein the second URL address comprises the numerical digits of the phone number in an ordered sequence.

5. The method of claim 1, wherein the second URL address is configured to function as a root webpage for a user associated with the phone number associated with the second URL address.

6. The method of claim 1, further comprising:
providing access to a game based upon accessing the second URL address.

7. The method of claim 6, wherein the game comprises:
a plurality of identifiable game pieces displayed on a playing surface, wherein one or more of the plurality of identifiable game pieces are randomly associated with a prize.

8. The method of claim 1, further comprising:
associating a user's telephony-based communicating with a user's web-based communicating using the stored phone number.

9. The method of claim 1, further comprising:
displaying an advertisement on a web page associated with the second URL address based upon the stored phone number and the recorded interactions with the website associated with the second URL address.

10. A computer system for identifying and communicating with a user, comprising:
at least one processor; and
a tangible computer-readable medium storing program code segments, the program code segments configured to cause the at least one processor to perform the following operations:
receiving a predefined keyword directed to a predefined shortcode from a mobile device;
storing a phone number associated with the mobile device;
generating a unique URL address based upon the keyword, the shortcode and the stored phone number, wherein the unique URL address comprises encrypted alpha-numeric characters of the phone number;
transmitting the unique URL address to the mobile device;
receiving a request from the mobile device to access the unique URL address;
resolving the unique URL address to a second URL address comprising numerical digits of the phone number;
recording user interactions with the website based upon the second URL address;
generating user analytic information based upon the recording; and
communicating information to the user via the mobile device based upon the stored phone number and the second URL address.

11. The system of claim 10, wherein the second URL address comprises the numerical digits of the phone number in an ordered sequence.

12. The system of claim 10, wherein the second URL address is configured to function as a root webpage for a user associated with the phone number associated with the second URL address.

13. The system of claim 10, further comprising:
providing access to a game based upon accessing the second URL address;
displaying advertisements during accessing of the game;

14. The system of claim 13, wherein the game comprises:
a plurality of identifiable game pieces displayed on a playing surface, wherein one or more of the plurality of identifiable game pieces are randomly associated with a prize.

15. The system of claim 10, further comprising:
associating a user's telephony-based communicating with a user's web-based communicating using the stored phone number.

16. The system of claim 10, further comprising:
displaying an advertisement on a web page associated with the second URL address based upon the stored phone number and the recorded interactions with the website associated with the second URL address.

17. A tangible computer-readable medium storing program code segments, the program code segments configured to cause a processor to perform a method, the method comprising:
receiving a predefined keyword directed to a predefined shortcode from a mobile device;
storing a phone number associated with the mobile device;
generating a unique URL address based upon the keyword, the shortcode and the stored phone number, wherein the unique URL address comprises encrypted alpha-numeric characters of the phone number;
transmitting the unique URL address to the mobile device;
receiving a request from the mobile device to access the unique URL address;
resolving the unique URL address to a second URL address comprising numerical digits of the phone number in an ordered sequence;
recording user interactions with the website based upon the second URL address;
generating user analytic information based upon the recording;
communicating information to the user via the mobile device based upon the stored phone number and the second URL address; and
displaying an advertisement on the website associated with the second URL address based upon the stored phone number and the recorded interactions with the website associated with the second URL address.

18. The method of claim 17, wherein the second URL address is configured to function as a root webpage for a user associated with the phone number associated with the second URL address.

19. The method of claim 17, further comprising:
providing access to a game based upon accessing the second URL address;
displaying advertisements during accessing of the game;

20. The method of claim 17, further comprising:
associating a user's telephony-based communicating with a user's web-based communicating using the stored phone number.
